(19) United States
(12) Patent Application Publication
(10) Pub. No.: US 2024/0424968 A1
(43) Pub. Date: Dec. 26, 2024

(54) Systems And Methods For Delivering Air To The Neck Of A Vehicle Driver Or Passenger

(71) Applicant: JB Poindexter & Company, Houston, TX (US)

(72) Inventors: Andrea Chamma, Ypsilanti, MI (US); Adam Klauer, Ann Arbor, MI (US); Scott Wolas, Pasadena, CA (US)

(21) Appl. No.: 18/751,597

(22) Filed: Jun. 24, 2024

Related U.S. Application Data
(60) Provisional application No. 63/509,869, filed on Jun. 23, 2023.

(51) Int. Cl. B60N 2/879; B60N 2/56

(52) U.S. Cl. CPC B60N 2/879; B60N 2/5628; B60N 2/5657

(57) ABSTRACT

Blower systems for providing air (e.g., heated or cooled air) to a driver or passenger of a vehicle (e.g., a delivery or commercial vehicle) are disclosed. The blower systems can be positioned for blowing air against the neck of the driver or passenger, and can be configured to passively adapt to direct airflow for different heights of the driver or passenger.

### CROSS-REFERENCE TO RELATED APPLICATION

This application claims priority to and the benefit of the filing date of U.S. Provisional Patent Application No. 63/509,869, filed Jun. 23, 2023, the entirety of which is hereby incorporated by reference herein.

### FIELD

This disclosure relates to systems and methods for providing air (e.g., heated or cooled air) to a driver or passenger of a vehicle (e.g., a delivery vehicle). In exemplary aspects, the disclosure relates to a passive-adjustment neck blower system.

### BACKGROUND

In some vehicles, seats can be equipped with embedded neck blowers having rotating vents. However, these neck blowers must be rotated manually (or otherwise manually adjusted), and they are provided with a fixed bezel that is easily and frequently blocked by the seat occupant's clothing (jacket, hood, etc.). Accordingly, there is a need for neck blower systems that provide improved air coverage for drivers and passengers of various torso lengths/heights.

### SUMMARY

Disclosed herein are neck blower systems that provide effective thermal comfort to a wide range of torso heights (e.g., ranging from the bottom 5% of female torso heights to the top 5% of male torso heights), while avoiding or limiting the need for manual adjustment.

Additional advantages of the disclosed apparatuses, systems, and methods will be set forth in part in the description that follows, and in part will be obvious from the description, or may be learned by practice of the claimed invention. The advantages of the disclosed devices and systems will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION OF THE DRAWINGS

These and other features of the preferred embodiments of the invention will become more apparent in the detailed description in which reference is made to the appended drawings wherein:

FIG. 1 shows a known neck blower design having a manually rotatable vent design.

FIG. 2 depicts an exemplary blower system as disclosed herein.

FIG. 3 depicts another exemplary blower system as disclosed herein.

FIG. 4 depicts another exemplary blower system as disclosed herein.

FIG. 5 depicts another exemplary blower system as disclosed herein.

FIG. 6A depicts an exemplary vent outlet of an exemplary blower system as disclosed herein, wherein the vent outlet comprises a pair of vertically elongated openings. 6B illustrates a schematic side view of the exemplary blower system of FIG. 6A.

FIG. 7A depicts another exemplary blower system as disclosed herein. FIG. 7B depicts a blower system including rotating vanes for use in the exemplary blower system of FIG. 7A.

FIG. 8 is a front perspective view of a seat assembly as disclosed herein.

FIG. 9 is a rear perspective view of the seat assembly of FIG. 8.

FIG. 10 is a cross-sectional view of the seat assembly of FIG. 8.

FIG. 11 is an exploded view of the seat assembly of FIG. 8.

FIG. 12 is a side view of an individual having the torso height at the bottom 5% of female torso heights using the seat assembly of FIG. 8.

FIG. 13 illustrates operation of the vent outlet with the individual of FIG. 12.

FIG. 14 illustrates the position of an individual having the torso height at the top 5% of male torso heights using the seat assembly of FIG. 8.

FIG. 15 illustrates operation of the vent outlet with the individual of FIG. 14.

FIG. 16 is a schematic diagram of an exemplary vehicle as disclosed herein.

FIG. 17 is a rear perspective view of portions of a seat assembly as disclosed herein.

FIG. 18 illustrates an exemplary diffusion material.

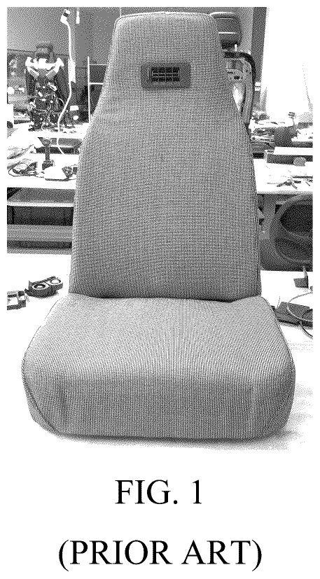

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a,” “an,” and “the” include plural referents unless the context clearly dictates otherwise. For example, use of the term “a vacuum hose” can refer to one or more of such vacuum hoses, and so forth.

All technical and scientific terms used herein have the same meaning as commonly understood to one of ordinary skill in the art to which this invention belongs unless clearly indicated otherwise.

As used herein, the terms “optional” or “optionally” mean that the subsequently described event or circumstance may or may not occur, and that the description includes instances where said event or circumstance occurs and instances where it does not.

As used herein, the term “at least one of” is intended to be synonymous with “one or more of.” For example, “at least one of A, B and C” explicitly includes only A, only B, only C, and combinations of each.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

The following description supplies specific details in order to provide a thorough understanding. Nevertheless, the skilled artisan would understand that the apparatus, system, and associated methods of using the apparatus can be implemented and used without employing these specific details. Indeed, the apparatus, system, and associated methods can be placed into practice by modifying the illustrated apparatus, system, and associated methods and can be used in conjunction with any other apparatus and techniques conventionally used in the industry.

Disclosed herein are various implementations of a blower system for a seat that allows air to flow to unblocked portions of the blower outlet area (referred to also herein as a “vent outlet”), thereby allowing the seat occupant to be conditioned where the blockage of the outlet area by the occupant stops. In use, the disclosed blower systems do not require an external adjustment mechanism or a more expensive electronic adjustment. It is contemplated that the disclosed blower systems can self-regulate based on occupant size, position, clothing, and other factors without the need for active occupant interaction.

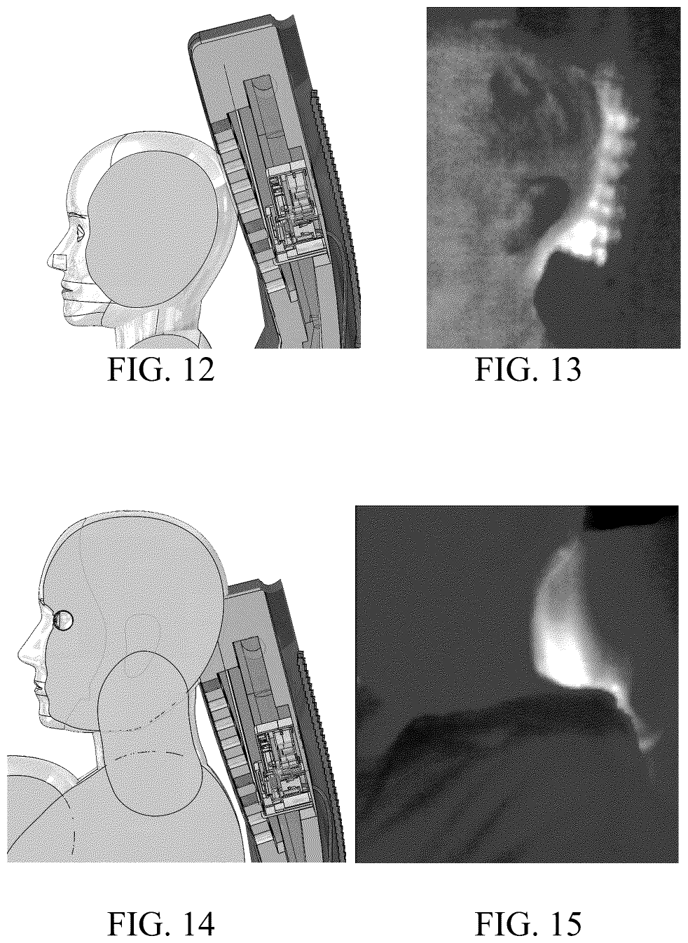

Referring to FIGS. 12-15, the disclosed seat assemblies and blower systems can be configured to effect airflow across the neck of individuals (e.g., drivers or passengers) of various heights. For example, FIG. 12 illustrates the position of an individual having the torso height at the bottom 5% of female torso heights relative to the vent outlet. FIG. 13 illustrates operation of the vent outlet with the individual of FIG. 12. As shown, the head of the individual blocks an upper portion of the vent outlet, causing the flow to exit the portion of the vent outlet at the neck of the individual. FIG. 14 illustrates the position of an individual having the torso height at the top 5% of male torso heights relative to the vent outlet. FIG. 15 illustrates operation of the vent outlet with the individual of FIG. 14. As shown, the back and shoulders of the individual block a lower portion of the vent outlet, causing the flow to exit the portion of the vent outlet at the neck of the individual. This illustrates capability of the system to passively adjust airflow for different user heights.

In some aspects, effectiveness of the disclosed blower systems can be achieved at least in part by the position and area of the vent outlet. Advantageously, by providing effective airflow of conditioned air across the neck of the individual, the individual can be provided a desired level of comfort at a greater efficiency. For example, the cab of the vehicle can be kept at a higher temperature, thereby requiring less air conditioning for the entire cab, while achieving the same level of comfort for the individual.

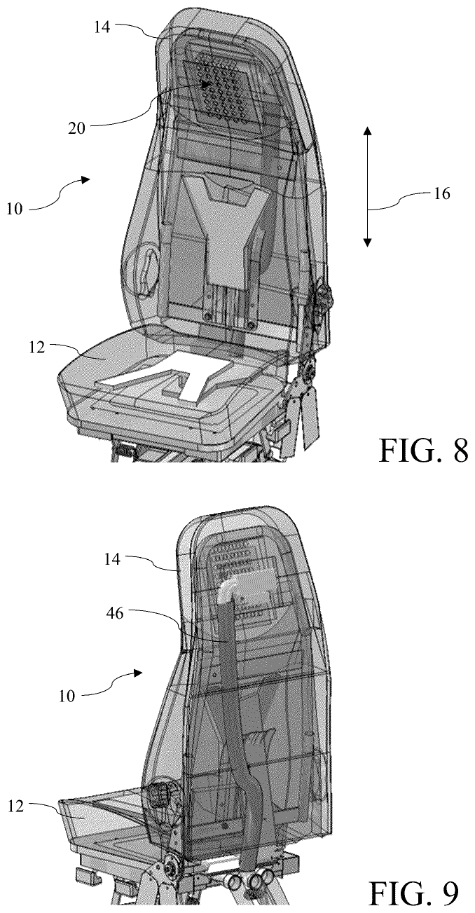

Referring to FIGS. 8-11, an exemplary seat assembly 10 can comprise a seat 12 and a seatback 14 extending upwardly from the seat. The seatback 14 can define a vent outlet 20. The illustrated embodiment of the vent outlet 20 comprises a plurality of openings 22. The plurality of openings 22 collectively and cooperatively define the vent outlet 20. In exemplary aspects, the plurality of openings 22 can be arranged in a grid. Although the vent outlet 20 is illustrated as a plurality of openings 22, in other aspects, the vent outlet 20 can comprise a single opening covered by a permeable material, such as a screen or fabric.

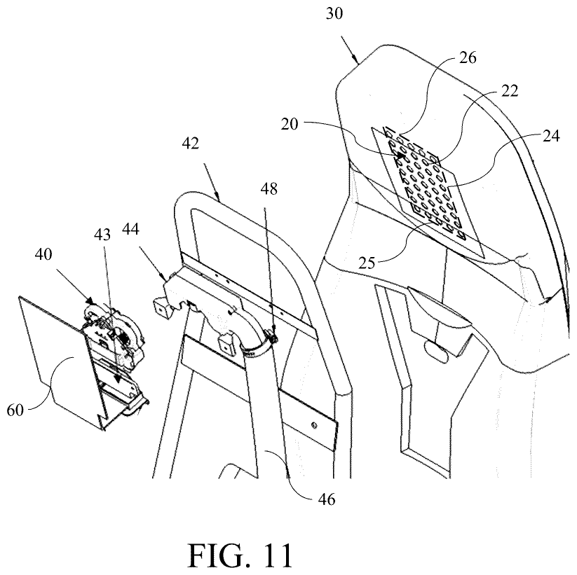

In exemplary aspects, the vent outlet 20 can have a vertical dimension, as measured along an axis 16 that extends along the seatback 14. (Accordingly, the vertical dimension can adjust relative to the seatback in any reclined position.) In aspects in which the vent outlet 20 comprises a plurality of openings 22, the vent outlet 20 can have dimensions defined by a peripheral border 24 that tangentially surrounds the plurality of openings (shown as rectangle in broken lines in FIG. 11). In various exemplary aspects, the vertical dimension of the vent outlet 20 can be from about 4 inches to about 10 inches. For example, the vertical dimension of the vent outlet 20 can be at least 6 inches, or from about 5 inches to about 9 inches, or about 8 inches. In further exemplary aspects, the horizontal dimension of the vent outlet 20 can be from about 2 inches to about 8 inches, or from about 3 inches to about 6 inches, or about 4 inches. In exemplary, optional aspects, the openings 22 can have a major dimension (e.g., diameter) from about

The vent outlet 20 can be spaced from the seat to overlie a neck of an individual seated in the seat. For example, the vent outlet 20 can have a lower end 25 that is spaced from the seat from about 18 inches to about 26 inches (optionally, from about 20 inches to about 24 inches).

The seatback 14 can comprise a resilient support structure 30. The resilient support structure 30 can define the vent outlet 20. For example, the resilient support structure 30 can define the plurality of openings 22 that cooperate to define the vent outlet 20. In some aspects, the resilient support structure 30 can comprise foam. In other aspects, the resilient support structure 30 can comprise elastic fabric.

The seat assembly 10 can further comprise a blower 40 configured to effect airflow out the vent outlet. Optionally, the blower 40 can be embedded in the seatback. For example, the seatback 14 can comprise a frame 42. At least one bracket 43 can couple the blower 40 to the frame 42. In further aspects, the seat assembly 10 can comprise a housing 44 that supports the blower 40. The housing 44 can couple to the bracket 43.

The seat assembly 10 can further comprise a conduit 46 in fluid communication with the vent outlet 20. The conduit 46 can be configured to communicate air from an air conditioned source. For example, a vehicle within which the seat assembly 10 is positioned can comprise an air conditioner, and the conduit 46 can receive air from the air conditioner. The conduit 46 can comprise, for example, a vacuum hose. The conduit 46 can be configured to flex to permit reclining of the seat. A hose clamp 48 can secure the conduit 46 to the housing 44. The conduit 46 can comprise a rigid connection for strain relief.

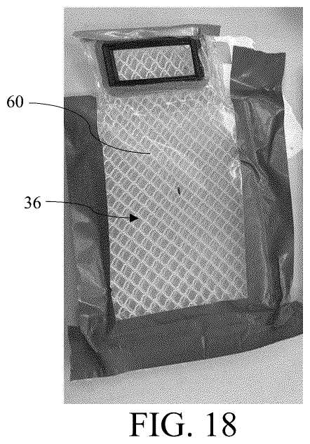

The resilient support structure 30 can comprise a front side 32 and a back side 34. The plurality of openings 22 can extend from the front side 32 to the back side 34. The seat assembly 10 can further comprise a diffusion region 36 on the back side 34. The diffusion region 36 can extend across each opening 22 of the plurality of openings. In this way, the diffusion region can provide fluid communication between each opening 22 of the plurality of openings so that if one or more is blocked (or partially blocked, thereby providing a back pressure), air can be redirected to the remaining unblocked/unobstructed openings. Optionally, referring to FIG. 3, a diffusion material 60 can be provided within the diffusion region 36. The diffusion material can provide support to maintain the diffusion region 36 open to permit airflow therethrough. In further aspects, the diffusion material can be configured to diffuse flow across the diffusion region. For example, the diffusion material can comprise an entangled fibrous material or an open cell foam. FIG. 18 illustrates an exemplary diffusion material 60. A housing (e.g., flexible polymer material) surrounds the diffusion material 60 to partially enclose the diffusion region 36. The housing defines an opening to provide communication to the blower.

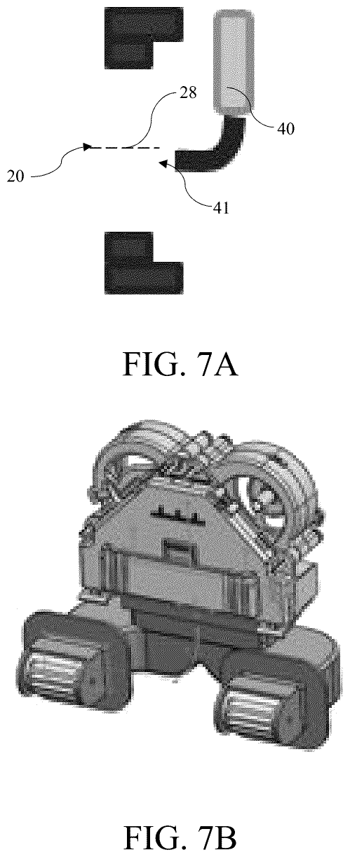

Referring to FIG. 6B, the vent outlet 20 can have a lower end 25, an upper end 26 spaced from the lower end along the axis 16, and a midline 28 equally spaced between the upper end and the lower end. In some optional aspects, the blower 40 can be in communication with the diffusion region at a location 41 offset from the midline of the vent outlet (e.g., below the midline 28). For example, the blower can have an outlet at the location 41, or a separate conduit can extend between the outlet and the location 41 to direct flow to the location 41. In other aspects, said location 41 can be provided at or near the midline 28, as shown in FIG. 7A.

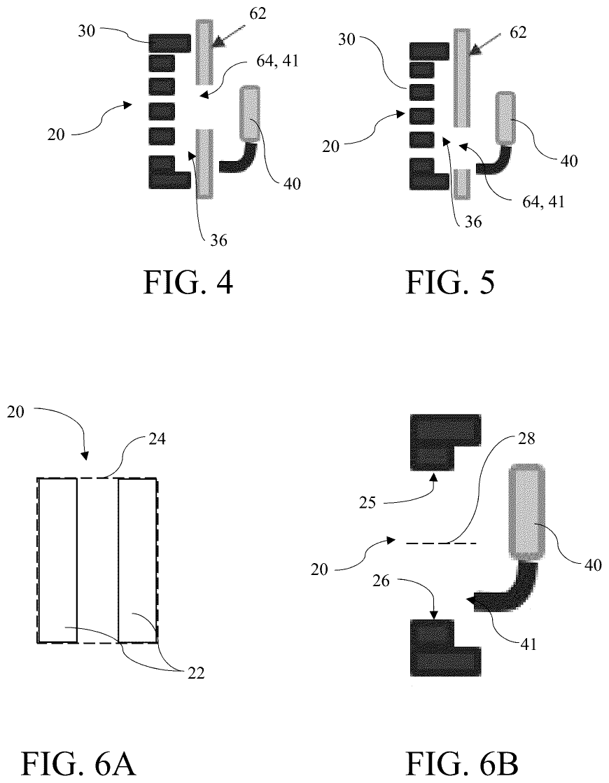

Referring to FIGS. 4-5, the seat assembly 10 can further comprise a partition 62 between the blower 40 and the diffusion region 36 along a direction of flow, wherein the partition defines at least one opening 64 defining the location 41 offset from the midline of the vent outlet. In this way, the partition 62 can control entry of flow from the blower to the diffusion region 36. For example, in exemplary aspects, and as shown in FIG. 5, it can be advantageous to provide the location 41 below the midline of the vent outlet so that, for shorter torsos, the air can be directed toward the lower end of the vent outlet 20. For taller individuals, the lower portion of the vent outlet 20 can be blocked by the back and shoulders, causing the air to flow upwardly.

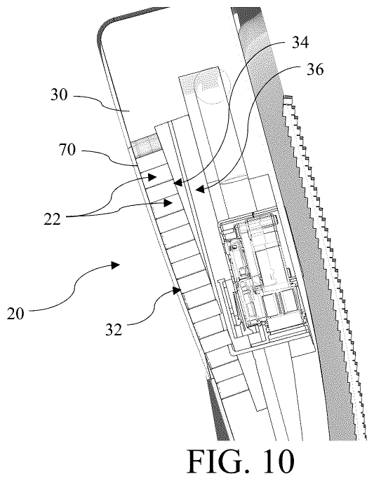

Referring to FIG. 10, the seat assembly 10 can further comprise a covering material 70 positioned over the vent outlet 20. The covering material 70 can comprise, for example, fabric, vinyl, or leather.

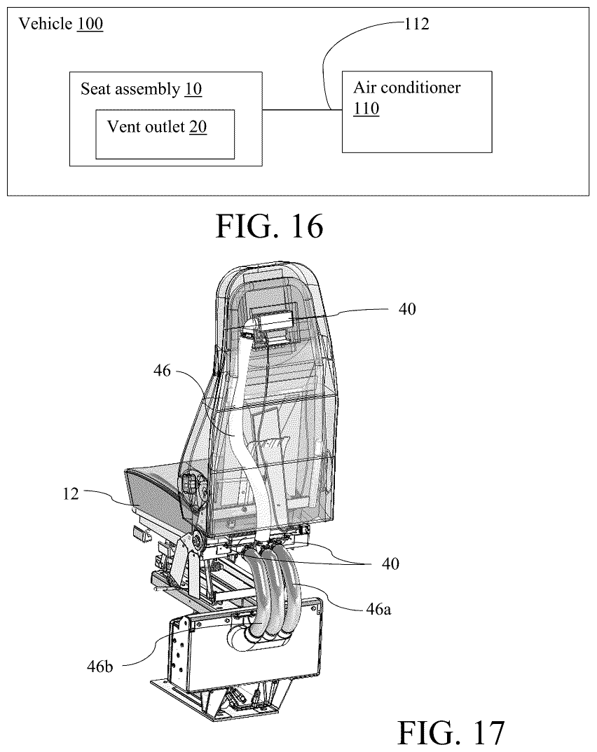

Referring to FIG. 16, a vehicle 100 can comprise a seat assembly 100 and an air conditioner having an air conditioned air outlet 112. The vent outlet 20 can be in fluid communication with the air conditioned air outlet 112 of the air conditioner 110. Referring to FIG. 11, a blower 40 configured to effect airflow out the vent outlet 20. For example, optionally, the blower 40 can be embedded in the seatback 14. In exemplary aspects, the vehicle can comprise other outlets for the air conditioner 110, including, for example, one or more of: the dashboard, the steering wheel, the seat, or an outlet of the seatback that is separate from the vent outlet 20. In some aspects, flow through the vent outlet 20 can be controlled (e.g., by permitting selective control of the blower 40). The vehicle can comprise a plurality of blowers that are configured to effect flow through different outlets of the vehicle. Optionally, the plurality of blowers can be independently controlled.

FIG. 17 illustrates a perspective view of a seat back having a plurality of outlets for conditioned air. For example, a first additional conduit 46a can communicate conditioned air to a vent of the seatback 14 (FIG. 8) that is separate from the vent outlet 20 (FIG. 8), and a second additional conduit 46b can communicate conditioned air to the seat 12. Each conduit can be provided with a respective blower 40.

### EXAMPLES

### Blower Systems Having Ducts

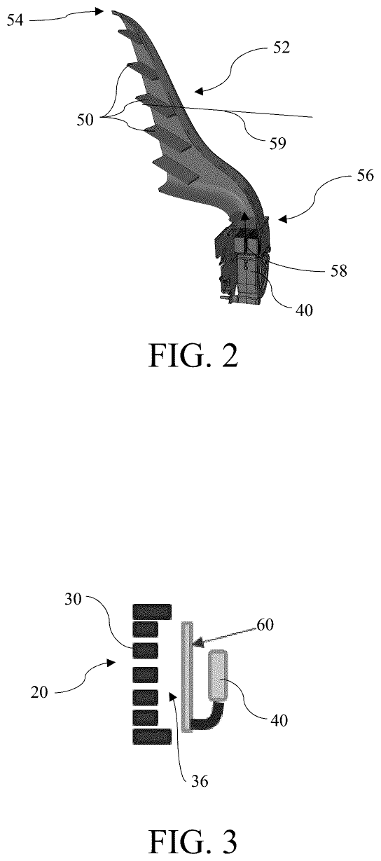

With reference to FIG. 2, in various aspects, a blower can be in communication with a ventilation structure, which can comprise a duct and a plurality of vents and/or vanes. In exemplary aspects, the ventilation structure comprises a soft TPU or similar material. For shorter torsos, air exits the bottom vents toward the neck of the seat occupant. For longer torsos, shoulder contact with the seat blocks the lower vents, forcing air to exit through the upper vents. As shown, the vents can be angled upwardly. Optionally, in some aspects, vanes can move with a hinge or compliant mechanism.

Referring to FIG. 2, in some optional aspects, the seat assembly can further comprise at least one baffle 50 that is configured to control flow through the seatback toward the vent outlet. For example, the seat assembly can comprise a flow housing 52, and the at least one baffle 50 can be positioned within the flow housing. In some aspects, the flow housing can comprise a top 54, a bottom 56, and an inlet 58. The inlet can be offset relative to a midline 59 between the top and the bottom of the flow housing. For example, the inlet can be provided at the bottom 56 of the flow housing 52.

### Blower Systems Having Perforated Foam Layers

With reference to FIG. 3, in various aspects, instead of comprising a duct, the ventilation structure can comprise a layer of spacer fabric and a foam layer with openings (e.g., perforated holes). In use, the spacer can allow easy airflow axially through the spacer. For a short torso, air can travel through the lower exit. If the air is blocked by a longer torso, the spacer can allow air to travel laterally or vertically until an opening is found.

With reference to FIGS. 4-5, in various aspects, it is contemplated that the blower system can comprise a sheet (e.g., a plastic sheet) having a slot located at the center (FIG. 4) or bottom (FIG. 5) of the sheet, along with a foam layer having openings (e.g., perforated holes).

### Blower Systems Having Slotted Foam Layers

With reference to FIG. 6, in various aspects, the blower system can include a passive manifold and a foam layer having two vertical slots, with the manifold being in communication with the vertical slots. In use, air can travel through the slots and exit on either side of the seat occupant's head. For a short torso, air can travel through the lower part of the slots. If blocked by a longer torso, the slots allow air to travel laterally or vertically until an opening is found.

With reference to FIGS. 7A and 7B, in various aspects, the blower system can include a foam layer having two vertical slots. In these aspects, rotating vanes can be coupled to the manifold to direct air up or down in the respective slots. It is contemplated that the blower system can further comprise a lever or knob to rotate the vanes to the selected orientation.

Although the foregoing invention has been described in some detail by way of illustration and example for purposes of clarity of understanding, certain changes and modifications may be practiced within the scope of the appended claims.

What is claimed is:

1. A seat assembly comprising:
a seat; and
a seatback extending upwardly from the seat, wherein the seatback defines a vent outlet, the vent outlet having a vertical dimension from about 4 inches to about 10 inches, wherein the vent outlet is spaced from the seat to overlie a neck of an individual seated in the seat.

2. The seat assembly of claim 1 wherein the vent outlet has a lower end that is spaced from the seat from about 20 inches to about 30 inches.

3. The seat assembly of claim 1, wherein the seatback comprises a resilient support structure, wherein the resilient support structure defines a plurality of openings, wherein the plurality of openings cooperate to define the vent outlet.

4. The seat assembly of claim 3, wherein the resilient support structure comprises foam.

5. The seat assembly of claim 1, wherein the vertical dimension of the vent outlet is at least 6 inches.

6. The seat assembly of claim 1, further comprising a blower configured to effect airflow out the vent outlet.

7. The seat assembly of claim 1, wherein the blower is embedded in the seatback.

8. The seat assembly of claim 1, further comprising a conduit in fluid communication with the vent outlet, wherein the conduit is configured to communicate air from an air conditioned source.

9. The seat assembly of claim 8, wherein the conduit comprises a vacuum hose.

10. The seat assembly of claim 1, further comprising at least one baffle that is configured to control flow through the seatback toward the vent outlet.

11. The seat assembly of claim 10, further comprising a flow housing, wherein the at least one baffle is positioned within the flow housing.

12. The seat assembly of claim 11, wherein the flow housing comprises a top, a bottom, and an inlet, wherein the inlet is offset relative to a midline between the top and the bottom of the flow housing.

13. The seat assembly of claim 4, wherein the resilient support structure comprises a front side and a back side, wherein the plurality of openings extend from the front side to the back side, wherein the seat assembly further comprises a diffusion region on the back side, wherein the diffusion region extends across each opening of the plurality of openings.

14. The seat assembly of claim 12, further comprising a diffusion material that is configured to diffuse airflow across the diffusion region.

15. The seat assembly of claim 14, wherein the diffusion material comprises an entangled fibrous material or an open cell foam.

16. The seat assembly of claim 13, further comprising a blower configured to effect airflow out the vent outlet, wherein the vent outlet has a lower end, an upper end spaced from the lower end along a vertical axis, and a midline equally spaced between the upper end and the lower end, wherein the blower is in communication with the diffusion region at a location offset from the midline of the vent outlet.

17. The seat assembly of claim 16, further comprising a partition between the blower and the diffusion region along a direction of flow, wherein the partition defines at least one opening defining the location offset from the midline of the vent outlet.

18. The seat assembly of claim 1, further comprising a covering material positioned over the vent outlet.

19. A vehicle comprising:
an air conditioner having an air conditioned air outlet;
seat assembly comprising:
a seat; and
a seatback extending upwardly from the seat, wherein the seatback defines a vent outlet, the vent outlet having a vertical dimension from about 4 inches to about 10 inches, wherein the vent outlet is spaced from the seat to overlie a neck of an individual seated in the seat,
wherein the vent outlet is in fluid communication with the air conditioned air outlet of the air conditioner; and
a blower configured to effect airflow out the vent outlet.

20. The vehicle of claim 19, wherein the blower is embedded in the seatback.
